(19) United States
(12) Patent Application Publication
(10) Pub. No.: US 2019/0177625 A1
(43) Pub. Date: Jun. 13, 2019

(54) METHOD FOR PROCESSING VISCOUS OIL OR OIL PRODUCTS AND A PLANT FOR THEIR REFINING.

(71) Applicant: Alex Prutkovsky, New York, NY (US)

(72) Inventor: Alex Prutkovsky, New York, NY (US)

(21) Appl. No.: 15/616,893

(22) Filed: Jun. 7, 2017

Related U.S. Application Data
(60) Provisional application No. 62/348,129, filed on Jun. 9, 2016.

(51) Int. Cl. C10G 67/16; B01J 19/24; B01J 19/00

(52) U.S. Cl. CPC C10G 67/16; B01J 19/245; B01J 19/008; B01J 19/0013; B01J 2219/00051; C10G 2300/302; B01J 2219/0002; B01J 2219/00006; C10G 2300/4006

(57) ABSTRACT

The invention describes and claims a processing plant and a method for processing viscous oil and oil products. The processing is effectuated with a plant, which comprises a plurality of reaction modules, a plurality of rectifying chambers and pipelines. Each reaction module and each rectifying chamber comprises a tank, a pump, a hydrocavitation generator. Each reaction module comprises a plurality of intermediate reaction stages. Each rectifying chamber comprises a plurality of intermediate rectifying stages. The reaction module and the rectifying chamber are interconnected. Intermediate reaction stages are connected by pipelines, with the last one connected to a rectifying chamber.

This application claims priority to provisional application #62/348,129 for METHOD FOR PROCESSING VISCOUS Oil OR OIL PRODUCTS AND THE PLANT FOR THEIR REFINING, filed on Jun. 9, 2016

### FIELD OF THE INVENTION

The invention relates to oil producing, oil refining, chemical and petrochemical industries, particularly to changing the initial feedstock properties, that is, to processing viscous oil or oil products, including viscosity reduction, refining and cracking.

### BACKGROUND OF THE INVENTION

A number of approaches for processing of viscous oil and oil products exist and are described below. However, all currently-existing solutions are characterized by low efficiency of the process, high energy consumption and/or require the application of additional heating or the use of chemical agents.

One method of vortex cracking of oil and oil products (see patent RU 2305699 C1, 2007. 09. 10), includes a separation of oil or oil products into fractions. This method is implemented by feeding oil or oil products into a vortex hydrocavitation facility, after processing in which the product is returned into a tank for oil and oil products, from where they are fed into a vortex tube for separation into fractions.

Among the known methods is a method for separating emulsions, particularly high-viscosity stable emulsions (see patent RU 2286194 C2, 2006. 10. 27), which includes a jet supply of an emulsion carried out in the form of a vortex swirling flow. In its central zone, through the use of centrifugal forces, a reduced pressure equal to the pressure of a saturated vapor of a low-boiling liquid is created. And in its peripheral zone, a pressure is produced, which pressure provides displacement of a low-boiling liquid to the central zone of the vortex swirling flow. Part of the peripheral flow is withdrawn into the initial emulsion for circulation; the emulsion vortex flow is heated to the temperature of a saturated vapor by means of shock diffusion, and after applying shock diffusion, the heated central and peripheral flows are withdrawn into the initial emulsion for recirculation.

As stated above, disadvantages of these known methods are insufficient efficiency as well as high energy consumption of processing viscous oil or oil products, including viscosity reduction, refining and cracking. Processing facilities known in the art also have a number of other deficiencies that are resolved by the present invention.

For example, a processing facility is described in the patent related to the method for separating emulsions, particularly high-viscosity stable emulsions (see patent RU 2286194 C2, 2006. 10. 27). The processing facility contains a catcher tank, pump, vortex generator, shock diffusion device. The intake fitting of the pump is connected by pipelines to the source of the initial emulsion, with the catcher tank and with the peripheral flow extraction fitting located behind the shock diffusion device; the pump's discharge fitting is connected to the vortex generator; the near-axial flow extraction fitting located behind the shock diffusion device as well as the fitting located in front of the shock diffusion device are both connected by pipelines to the catcher tank.

Also known in the art are facilities for vortex cracking of oil and oil products (see patent RU 2305699 C1, 2007. 09. 10), which contains a tank for oil and oil products, rectifying chamber and reaction modules, a tank for extracted products. The tank for oil and oil products is connected to rectifying chamber and reaction modules by means of a double-position valve and oil pumps. The rectifying chamber is designed as a vortex hydrocavitation facility, which contains, located in sequence, an input device, swirler, vortex tube, unswirler and an output device; a reaction module is designed as a vortex tube with a tangential inlet nozzle, collection chamber and a flow control valve; the vortex tube is connected to the tanks for collecting extracted fractions.

The numerous disadvantage of the known processing facilities include the impossibility of the given design to provide sufficient efficiency and low energy consumption in the course of processing viscous oil, including viscosity reduction, refining and cracking.

The technical problem solved by the proposed invention involves the improvement of efficiency of the process with regards to specific performance, decrease of the energy consumption of the viscous oil and oil products processing, including viscosity reduction, refining and cracking without applying any additional heating or using chemical agents.

### SUMMARY OF THE PRESENT INVENTION

The present invention is defined by the following claims and nothing in this section should be taken as a limitation on those claims.

The present invention describes and claims a plant and a method for processing viscous oil and oil products. The plant comprises a plurality of reaction modules, a plurality of rectifying chambers, pipelines, and a plurality of hydrocavitation generators. Each reaction module comprises a reaction module's tank, a pump and at least one (and in some embodiments, several) hydrocavitation generator. Each reaction module further comprises a plurality of intermediate reaction stages. These intermediate reaction stages further comprise a last intermediary reaction stage.

Each rectifying chamber comprises a rectifying chamber tank, a rectifying pump, at least one of the plurality of hydrocavitation generators. Each rectifying chamber comprises a plurality of intermediate rectifying stages.

The reaction module and the rectifying chamber are interconnected. The plurality of intermediate reaction stages are connected by pipelines. The last intermediary reaction stage is connected by the pipelines to a rectifying chamber;

Each of the plurality of intermediate reaction stages comprises a tank, a pump and at least one of hydrocavitation generators; said hydrocavitation generator comprising an outlet pipe. The outlet pipe of a hydrocavitation generator is connected via the inlet pipe to the reaction module's tank.

The method comprises the steps of providing viscous oil products into the plant of the present invention. The viscous oil products are then processed in a reaction module. Processing in a reaction module comprises the steps of: feeding the viscous oil products into the hydrocavitation generator to obtain a product, supplying the product to the fractionation device, and continuously and consecutively delivering and processing the feedstock in a recirculation mode at one or more subsequent stages within the reaction modules.

Preferred embodiments of the method of the present invention further comprise the step of carrying out the intermediary processing between the stages in an intermediary reaction module. Processing in the intermediary reaction stages comprises the steps of directing recirculated oil products (following a heat-mass exchange in the preceding tank) by way of a pump into the hydrocavitation generator of the interim module to obtain further reduction of the treated product viscosity, and subsequent delivery of the processed product to the next stage of the reaction module.

Kinematic viscosity of processed oil product is preferably measured at the output of the reaction module to ascertain whether the viscosity requirement is met. The level of viscosity at the output of one of the plurality of the hydrocavitation generators may be measured. If the level of viscosity has not reached the preset value, the under-processed oil product may be directed back to the tank of the preceding stage. If the level of viscosity has reached the preset value, treated oil product is preferably forwarded for final processing into a rectifying chamber.

In some of the preferred embodiments, the processing is carried out in a plurality of parallel-operating hydrocavitation generators at each stage of the reaction modules. The mass flow of the product fed into the one or more hydrocavitation generators is preferably equal to a multiple of the mass flow of the product fed into a reaction module.

### BRIEF DESCRIPTION OF THE DRAWINGS

FIG. 1 illustrates a schematic structure of the preferred embodiment of the plant of the present invention.

FIG. 2 depicts highly-detailed schematic structure of one of the preferred embodiments of the plant of the present invention.

FIG. 3 is a flowchart, illustrating a preferred embodiment of the method of the present invention.

### DETAILED DESCRIPTION OF THE PREFERRED EMBODIMENTS

The technical issues resolved by the present invention involve the improvements to efficiency of the process with regards to specific performance, decrease of the energy costs of processing of the viscous oil and oil products, including viscosity reduction, refining and cracking. All of the above is achieved without application of additional heating or use of chemical agents.

The technical issues are resolved due to novel distinctive features of the proposed plant and method for processing of viscous oil or oil products, including viscosity reduction, refining and cracking. One of these features is characterized by the fact that oil or oil products are continuously and consecutively fed into and processed in a recirculation mode at one or more subsequent stages within reaction modules (also known and referred to as “reaction cells”). Between those stages the intermediary processing is carried out, which is completed (if necessary) in a fractionation device; in this case the processing in each reaction module includes the heat-mass exchange provided in the tank, delivery by a pump and processing in one or more hydrocavitation generators connected by a parallel hydraulic connection as well as its further feeding into the initial tank. From this tank the product is supplied to an intermediate stage for further processing, which includes feeding by a pump and treatment in a hydrocavitation generator as well as subsequent delivery to the next stage, in which case the raw material mass flow is chosen to be equal to the mass flow of the processed product.

Another of the many distinctive novel features of the proposed plant for processing viscous oil or oil products, (including viscosity reduction, refining and cracking) is illustrated by the fact that the plant comprises one or more reaction modules' stages connected by pipelines and a provision of the intermediary reaction stages in between. The last intermediary stage is (if necessary) connected by a pipeline to a rectifying chamber or directly to a consumer of the processed oil or oil products. Each reaction module contains a tank, a pump and one or more hydrocavitation generators connected by a parallel hydraulic connection and pipelines, and the outlet pipe of the hydrocavitation generators is connected to the reaction module's tank; the intermediary reaction modules contain a pump and a hydrocavitation generator.

The processing plant and method of the present invention will now be illustrated by reference to the accompanying drawings. Preferred embodiments of the present invention have been assigned reference numeral 1000. Other elements have been assigned the reference numerals referred to below.

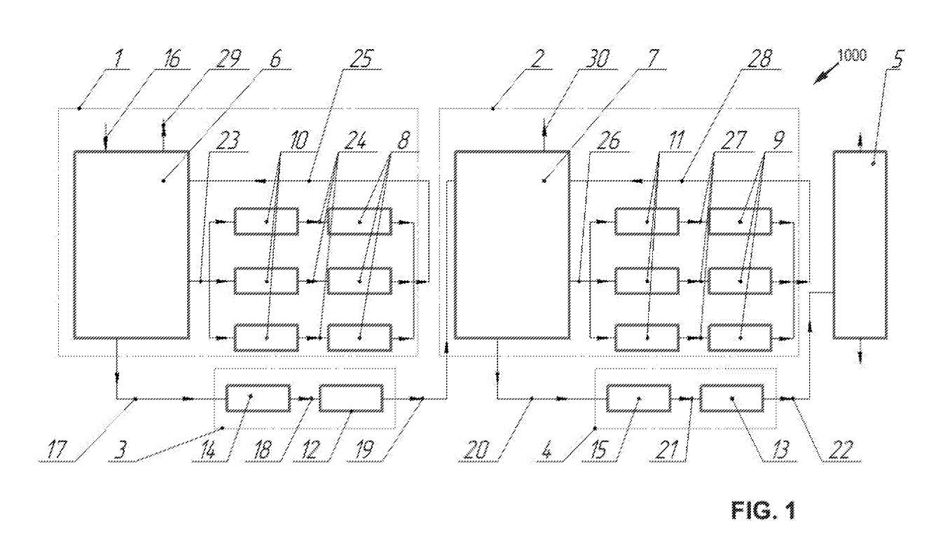

The proposed invention 1000 is illustrated by the drawings, where FIG. 1 shows the schematic structure of the plant, where each reaction module comprises several hydrocavitation generators, connected by a parallel hydraulic connection, using their own pumps.

The proposed plant (FIG. 1) comprises one or more stages of reaction modules 1 and 2 connected in sequence by pipelines to one or more intermediary reaction modules 3 and 4; reaction module 4 is connected by a pipeline to a rectifying chamber 5; each of reaction modules 1 and 2 comprises tanks 6 and 7 correspondingly, hydrocavitation generators 8 and 9 with pumps 10 and 11, and each of intermediary reaction modules 3 and 4 comprises hydrocavitation generators 12 and 13 with pumps 14 and 15.

Tank 6 of reaction module 1 comprises inlet fitting 16 connected to the source of the processed oil or oil products, and outlet pipe 17 connected to the input of pump 14 of reaction module 3; the outlet fitting of pump 14 is connected by pipeline 18 to the inlet fitting of hydrocavitation generator 12 of reaction module 3 and by pipeline 19 is connected to tank 7 of reaction module 2; the outlet fitting 20 of tank 7 is connected to pump 15 of reaction module 4; the outlet fitting of pump 15 is connected by pipeline 21 to hydrocavitation generator 13 of reaction module 4; and generator 13 is connected by outlet pipe 22 to rectifying chamber 5.

Tank 6 of reaction module 1 is connected by pipeline 23 to pumps 10, which have a parallel hydraulic connection, with their outlet fittings 24 connected to the inlet fittings of hydrocavitation generators 8 correspondingly, and the outlet fittings of generators 8 are connected by pipeline 25 to tank 6 of reaction module 1. Tank 7 of reaction module 1 is connected by pipeline 26 to pumps 11, which have parallel hydraulic connection; their outlet fittings 27 are connected correspondingly to the inlet fittings of hydrocavitation generators 9, outlet fittings of which are connected by pipeline 28 to tank 7 of reaction module 2.

Tanks 6 and 7 of reaction modules 1 and 2 correspondingly comprise fittings 29 and 30 for gaseous fraction discharge as well as for noncondensing gases extraction.

The proposed method is as follows. Tank 6 of reaction module 1 is filled with oil or oil products. After filling tank 6, circulating pumps 10 are turned on; they feed oil or oil products into hydrocavitation generators 8 providing recirculation mode in tank 6 of reaction module 1.

After reaching the preset parameters of oil in tank 6, continuous feeding of oil or oil products is provided through fitting 16 into tank 6 and through pipeline 17—to the input of pump 14 of intermediate reaction module 3, from where it is fed into hydrocavitation generator 12, where intermediate hydrocavitation processing of oil or oil products is carried out. In this case the flow of oil or oil products fed for processing into tank 6 and their flow into reaction module 3 are maintained equal.

The oil or oil products processed in the intermediary reaction module are fed into tank 7 of reaction module 2 from where it is fed into pumps and hydrocavitation generators 9.

From tank 7 of reaction module 2 oil or oil products are fed into reaction module 4 for the final hydrocavitation processing; the processing is completed (if necessary) in a fractionation device or oil or oil products are delivered directly to their consumer.

Processing in each reaction module (whether it is module 1 or module 2 includes heatmass exchange in a tank, delivery by a pump or pumps to one or more hydrocavitation generators for processing and further feeding into the initial tank. From this tank part of the oil or oil products are fed into pumps for recirculation while the other part is delivered to the intermediary stage for further processing, which includes delivery by a pump and processing in a hydrocavitation generator as well as further feeding into a reaction module of the next stage and so on; from there oil or oil products are fed into a rectifying chamber or delivered directly to their consumer.

If the goal is only to reduce the level of viscosity, then the process is limited to processing in one or more reaction modules depending on the level of viscosity of initial oil or oil products, the required output level of viscosity after processing and the method of implementation of a hydrocavitation generator's operation; in this case the mass flow of the oil or oil products delivered for processing is chosen to be equal to the mass flow of the processed oil or oil products. The mass flow of oil or oil products fed into hydrocavitation generators operating in a recirculation mode, shall be set to be equal to a multiple of the mass flow of oil or oil products, which are fed into a reaction module, and in case of using several parallel operating hydrocavitation generators, the mass flow in each of hydrocavitation generators shall be chosen to be equal to the mass flow of the product delivered for processing.

Under steady-state conditions the temperature in a tank at each reaction module stage is configured and maintained constant and equal to a mass-averaged temperature of the product in a tank.

During the processing, noncondensing gases are removed from each tank.

The proposed plant operates as follows (FIG. 1). Tank 6 of reaction module 1 is filled with oil or oil products through fitting 16. After filling tank 6, circulating pumps 10 are turned on; they are connected by pipeline 23 to tank 6, which provides feeding of oil or oil products along pipelines 24 into hydrocavitation generators 8; the processed oil or oil products are fed from them into tank 6 providing a recirculation mode in reaction module 1.

After reaching the preset parameters of oil in tank 6, continuous supply of oil or oil products is provided into tank 6 and through pipeline 17—to the input of pump 14 of intermediate reaction module 3, from where it is fed through pipeline 18 into hydrocavitation generator 12, where intermediate hydrocavitation processing of oil or oil products is carried out. In this case the flow of oil or oil products fed for processing into tank 6 and their flow into reaction module 3 are maintained equal.

The oil or oil products processed in the intermediary reaction module 3 are fed through pipeline 19 into tank 7 of reaction module 2, after filling which they are fed through pipeline 26 into pumps 11, from where they are fed through pipeline 27 into hydrocavitation generators 9, and through pipeline 28 the processed oil or oil products are returned to tank 7 of reaction module 2.

From tank 7 of reaction module 2 oil or oil products are fed through pipeline 20 into pump 15 of reaction module 4, from where they are fed through pipeline 21 into hydrocavitation generators 9; from there they are fed through pipeline 22 into rectifying chamber 5, where the processing is completed by fractionation or oil, or oil products are delivered directly to their consumer.

During the processing, noncondensing gases are removed from tanks 6 and 7 through fittings 29 and 30.

Application of hydrocavitation generators, which are forming strongly whirling counter-flows with high radial pressure gradient and highly developed anisotropic turbulence along with generated intensive acoustic vibrations, allows for influencing the flow of the processed oil or oil products by means of acoustic vibrations at sonic and ultrasonic frequencies, which in its turn leads to intensification of flow heating, enhancement of cavitation effects, formation of strong pressure pulses and intensification of heat-mass exchange processes. These factors account for destruction of paraffin, decomposition of chemical bonds (C—C) with free radicals and of carbamides formation in long molecules, separation of the mixture into light and heavy fractions, which in turn results in changing physical and chemical properties of oil, density decrease, viscosity reduction, etc.

Application of two and more stages' scheme for implementation of the operational process performed in main and intermediary reaction modules placed in sequence, which contains hydrocavitation generators, when carried out in recirculation mode in main reaction modules, allows: to increase the speed of viscosity reduction; to increase specific mass performance with regards to the processed oil or oil products, i.e. the performance related to the plant's mass, and to decrease the number of reaction modules' stages.

The use of parallel operating hydrocavitation generators in main reaction modules allows for applying hydrocavitation generators and their feeding pumps with the same geometric dimensions and technical specifications.

Thus the use of the proposed method and the plant 1000 for processing viscous oil and oil products, including viscosity reduction, refining and cracking, allows for improving the efficiency of the process with regards to specific performance, reducing energy consumption of the processing without applying any additional heating or using chemical agents.

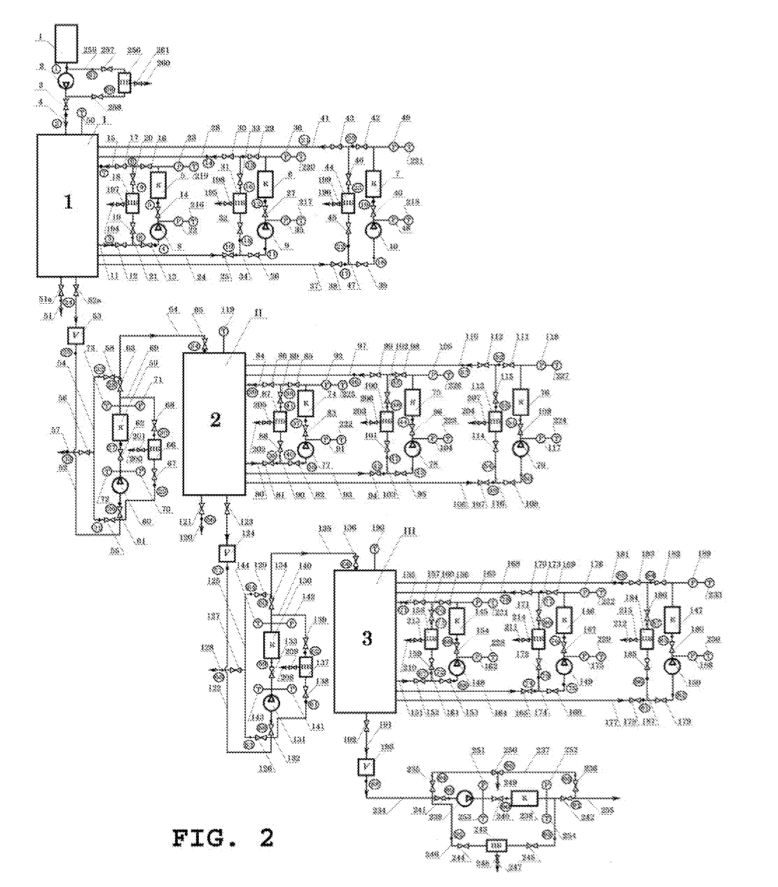

FIG. 2 depicts highly-detailed schematic structure of one of the preferred embodiments of the plant 1000 of the present invention. FIG. 2 illustrates the positioning and function of the following elements of the present invention:
I—First Stage Tank;
II—Second Stage Tank;
III—Third Stage Tank;
1—Feedstock Tank;
2—Feeding Pump;
3—Stop Valve;
4—Feeding Pipeline;
5, 6 and 7—Hydro-generators of the First Stage;
8, 9 and 10—Transfer Pumps of the First Stage;
11, 24 and 37—Feed Pipeline;
12, 13, 14, 25, 26, 27, 38, 39 and 40—Stop Valves;
15, 28 and 41—Offlake Pipeline;
16, 17, 29, 30, 42 and 43—Stop Valves;
18, 31 and 44—Flushing Tank;
19, 20, 32, 33, 45 and 46—Stop Valves;
21, 34 and 47—Flushing Pipeline;
22, 23, 35, 36, 48 and 49—Pressure Sensors (manometer);
50—Temperature Sensor (thermocouple probe);
51—Drainage Pipe;
51a—Stop Valve;
52—Feed Pipeline;
52a—Stop Valve;
53—Viscometer,
54—Drainage Pipe;
55, 56 and 58—Stop Valves;
57—Drain Connection;
59—Hydro-generator of the Interim Stage;
60—Transfer Pump of the Interim Stage;
61, 62 and 63—Stop Valves;
64—Offtake Pipeline;
65—Stop Valve;
66—Flushing Tank;
67 and 68—Stop Valves;
69—Flushing Pipeline;
70 and 71—Pressure Sensors (manometers);
72 and 73—Temperature Sensors (thermocouple probes);
74, 75 and 76—Hydro-Generators of the Second Stage;
77, 78 and 79—Transfer Pumps of the Second Stage;
80, 93 and 106—Feeding Pipeline;
81, 82, 83, 94, 95, 96, 107, 108 and 109—Stop Valves;
84, 97 and 110—Offlake Pipeline;
85, 86, 98, 99, 111 and 112—Stop Valves;
87, 100 and 113—Flushing Tank;
88, 89, 101, 102, 114 and 115—Stop Valves;
90, 103 and 116—Flushing Pipeline;
91, 92, 104, 105, 117 and 118—Pressure Sensors (manometers);
119—Temperature Sensor (thermocouple probe);
120—Drainage Pipe;
121—Stop Valve;
122—Feed Pipeline;
123—Stop Valve;
124—Viscometer;
125—Drainage Pipe;
126, 127 and 129—Stop Valves;
128—Drain Connection;
130—Hydro-generator of the Interim Stage;
131—Transfer Pup of the Interim Stage;
132, 133 and 134—Stop Valves;
135—Offtake Pipeline;
136—Stop Valve;
137—Flushing Tank;
138 and 139—Stop Valves;
140—Flushing Pipeline;
141 and 142—Pressure Sensors (manometers);
143 and 144—Temperature Sensors (thermocouple probes);
145, 146 and 147—Hydro-generators of the Third Stage;
148, 149 and 150—Transfer Pumps of the Second Stage;
151, 164 and 177—Feeding Pipeline;
152, 153, 154, 165, 166, 167, 177, 179 and 180—Stop Valves;
155, 168 and 181—Offtake Pipeline;
156, 157, 169, 170, 182 and 183—Stop Valves;
158, 171 and 184—Flushing Tank;
159, 160, 172, 173, 185 and 186—Stop Valves;
161, 174 and 187—Flushing Pipeline;
162, 163, 175, 176, 188 and 189—Pressure Sensors (manometers);
190—Temperature Sensor (thermocouple probe);
191—Drainage Pipe;
192—Stop Valve;
193—Viscometer;
194, 195 and 196—Drainage Pipe;
197, 198 and 199—Stop Valve;
200—Drainage Pipe;
201—Stop Valve;
202, 203 [symbol] 204—Drainage Pipe;
205, 206 and 207—Stop Valve;
208—Drainage Pipe;
209—Stop Valve;
210, 211 and 212—Drainage Pipe;
213, 214 and 215—Stop Valve;
216÷233—Temperature Sensors (thermocouple probes);
234—Feeding Pipeline of the Final Stage;
235 and 236—Stop Valves;
237—Flushing Pipeline;
238—Hydro-generators of the Final Stage;
239—Transfer Pumps of the Final Stage;
240, 241 and 242—Stop Valves;
243—Flushing Tank;
244 if 245—Stop Valves;
246—Flushing Pipeline;
247—Offtake Pipeline;
248—Stop Valve;
249—Drain Connection;
250—Stop Valve;
251 and 252—Pressure Sensors (manometers);
253 and 254—Temperature Sensors (thermocouple probes);
255—Drainage Pipe;
256—Flushing Tank of the Feeding Pump;
257 and 258—Stop Valves;
259—Flushing Pipeline;
260—Drain Connection;
261—Stop Valve;

The description of the preferred embodiment depicted on FIG. 2 is as follows:

1. First Stage

A feedstock of a very high viscosity is fed into a tank of the first stage I from the feedstock tank I by way of screw injection pump 2 through valve 3 via pipeline 4. Tangentially to the surface of the tank in the first stage I there are three hydro-generators 5, 6 and 7, where the cavitation treatment of the feedstock is carried out.

The feedstock to be processed is delivered to hydro-generator 5 by way of and through the first stage transfer pump 8 via feeding pipeline 11 through valves 12, 13 and 14. The feedstock processed in hydro-generator 5 is fed into the tank of the first stage I via offtake pipeline 15 through valves 16 and 17. Flushing of hydro-generator 5 and transfer pump 8 is carried out with a diesel fuel from flushing tank 18 through valves 19 and 20 via flushing pipeline 21. Control over the pressure level is carried out using pressure sensor 22 at the outlet of transfer pump 8 by means of the pressure sensor 23 at the outlet of hydro-generator 5.

The process in hydro-generator 5 is carried out as follows. Valves 19 and 20 on flushing pipeline 21 are closed. The supply of the feedstock to be processed is provided through the use of transfer pump 8 through opened valves 12, 13 and 14. After it has been processed, the feedstock is carried off to first stage tank I via offtake pipeline 15 through opened valves 16 and 17. For flushing hydro-generator 5 valves 12 and 17 are closed and valves 19 and 20 on flushing pipeline 21 are opened; as the result transfer pump 8 pumps diesel fuel over through hydro-generator 5 from flushing tank 18. Valves 13, 14 and 16 during the flushing process are opened. When the flushing process is over, valves 19 and 20 are closed, and, if necessary, valve 17 is opened simultaneously; as the result the flushing fuel is fed into first stage tank I. In case of failure of the transfer pump 8, valves 12, 13, 14, 16 and 17 are closed and the pump is replaced.

In the same way the feedstock to be processed is delivered to hydro-generator 6 by way of first stage transfer pump 9 via feeding pipeline 24 through valves 25, 26 and 27. The feedstock processed in hydro-generator 6 is fed into the tank of the first stage I via offtake pipeline 28 through valves 29 and 30. Flushing of hydro-generator 6 and transfer pump 9 is carried out with a diesel fuel from flushing tank 31 through valves 32 and 33 via flushing pipeline 34. Control over the pressure level is carried out using pressure sensor 35 at the outlet of transfer pump 9 and by means of the pressure sensor 36 at the outlet of hydro-generator 6.

The process in hydro-generator 6 is carried out as follows. Valves 32 and 33 on flushing pipeline 34 are closed. The supply of the feedstock to be processed is provided way of transfer pump 9 through opened valves 25, 26 and 27. After it has been processed, the feedstock is carried off to the tank of the first stage I via offtake pipeline 28 through opened valves 29 and 30. For flushing hydro-generator 6 valves 25 and 30 are closed and valves 32 and 33 on flushing pipeline 34 are opened; as the result, transfer pump 9 delivers diesel fuel over by way of the hydro-generator 6 from flushing tank 31. Valves 26, 27 and 29 during the flushing process are opened. When the flushing process is over, valves 32 and 33 are closed, and, if necessary, valve 30 is opened simultaneously; as the result. the flushing fuel is fed into the tank of the first stage I. In case of failure of the transfer pump 9, valves 25, 26, 27, 29 and 30 are closed and the pump is replaced.

In the same way the feedstock to be processed is delivered to hydro-generator 7 by way of the first stage transfer pump 10 via feeding pipeline 37 through valves 38, 39 and 40. The feedstock processed in hydro-generator 7 is fed into the tank of the first stage I via offtake pipeline 41 through valves 42 and 43. Flushing of hydro-generator 7 and transfer pump 10 is carried out with a diesel fuel from flushing tank 44 through valves 45 and 46 via flushing pipeline 47. Control over the pressure level is carried out using pressure sensor 8 at the outlet of transfer pump 10 and by means of the pressure sensor 49 at the outlet of hydro-generator 7.

The process in hydro-generator 7 is carried out as follows. Valves 45 and 46 on flushing pipeline 47 are closed. The supply of the feedstock to be processed is provided by way of the transfer pump 10 through opened valves 38, 39 and 40. After it has been processed, the feedstock is carried off to the tank of the first stage I via offtake pipeline 41 through opened valves 42 and 43. For flushing hydro-generator 7 valves 38 and 43 are closed and valves 45 and 46 on the flushing pipeline 47 are opened; as the result, transfer pump 10 delivers diesel fuel over by way of the hydro-generator 7 from flushing tank 44. Valves 39, 40 and 42 during the flushing process are opened. When the flushing process is over, valves 45 and 46 are closed, and, if necessary, valve 43 is opened simultaneously; as the result, the flushing fuel is fed into the tank of the first stage I. In case of failure of the transfer pump 10, valves 38, 39, 40, 42 and 43 are closed and the pump is replaced.

The processes in hydro-generators 5, 6 and 7 are carried out simultaneously and are repeated not less than 2÷3 times. Temperature control in first stage tank I is carried out by means of the thermocouple probe 50.

Drainage of the flushing fuel from the tank of the first stage I is carried out via drainage pipe 51 through valve 51a.

After processing in hydro-generators 5, 6 and 7 the feedstock from the tank of the first stage I is removed via pipeline 52 through valve 52a. The viscometer 53 is installed on a pipeline 52; the needs for further processing of the feedstock are determined according to this viscometer's readings. To the extent that the processing in the tank of the first stage I turns out to be sufficient and the viscosity value meets the stated requirements, the final product is drained via pipeline 54 through opened valves 55 and 56 through drain connection 57 with valve 58 closed.

To the extent that the viscosity value does not meet the stated requirements, the feedstock to be processed is supplied to hydro-generator 59 by way of the interim stage's transfer pump 60 via feeding pipeline 53 through valves 61, 62 and 63. The feedstock processed in hydro-generator 59 is fed into the tank of the second stage II via offtake pipeline 64 through valve 65. Flushing of hydro-generator 59 and transfer pump 60 is carried out with a diesel fuel from flushing tank 66 through valves 67 and 68 via flushing pipeline 69. Control over the pressure level is carried out using the pressure sensor 70 at the outlet of transfer pump 60 and by means of the pressure sensor 71 at the outlet of hydro-generator 59. Control over the temperature level is carried out using the temperature sensor 72 at the outlet of transfer pump 60 and by means of the temperature sensor 73 at the outlet of hydro-generator 59.

The process in hydro-generator 59 is carried out as follows. Valves 55 and 58 on drainage pipe 54 as well as valves 67 and 68 on flushing pipeline are closed. The supply of the feedstock to be processed is provided by way of the transfer pump 60 through opened valves 61, 62 and 63. After it has been processed, the feedstock is carried off to the tank of the second stage II via offtake pipeline 64 through opened valve 65. For flushing hydro-generator 59 valves 61 and 63 are closed and valves 67 and 68 on flushing pipeline 69 are opened; as the result, the transfer pump 60 delivers diesel fuel over by way of the hydro-generator 59 from flushing tank 66. Valve 62 during the flushing process is opened. When the flushing process is over, valves 67 and 68 are closed, and valves 55 and 58 are opened; as the result, the flushing fuel is drained via pipeline 54 through valve 56 of the drain connection 57. In case of failure of the transfer pump 60, valves 55, 58, 61, 62 and 63 are closed and the pump is replaced.

2. Second Stage

The feedstock to be processed is fed into the tank of the second stage 11 through valve 65 via pipeline 64. Three hydro-generators 74, 75 and 76, where the cavitation processing of the feedstock is carried out, are placed tangentially to the surface of the tank of the second stage II.

The feedstock to be processed is supplied to hydro-generator 74 by way of the second stage transfer pump 77 via feeding pipeline 78 through valves 80, 81 and 82. The feedstock processed in hydro-generator 74 is fed into the tank of the second stage II via offtake pipeline 84 through valves 85 and 86. Flushing of hydro-generator 74 and transfer pump 77 is carried out with a diesel fuel from flushing tank 87 through valves 88 and 89 via flushing pipeline 90. Control over the pressure level is carried out using the pressure sensor 91 at the outlet of the transfer pump 77 and by means of the pressure sensor 92 at the outlet of the hydro-generator 74.

The process in hydro-generator 74 is carried out as follows. Valves 88 and 89 on flushing pipeline 90 are closed. The supply of the feedstock to be processed is provided by way the transfer pump 77 through opened valves 81, 82 and 83. After it has been processed, the feedstock is carried off to the tank of the second stage 11 via offtake pipeline 84 through opened valves 85 and 86. For flushing hydro-generator 77 valves 81 and 86 are closed and valves 88 and 89 on flushing pipeline 90 are opened; as the result, the transfer pump 77 delivers diesel fuel over by way of the hydro-generator 74 from flushing tank 87. Valves 82, 83 and 85 during the flushing process are opened. When the flushing process is over, valves 88 and 89 are closed, and, if necessary, valve 86 is opened simultaneously; as the result, the flushing fuel is fed into the tank of the second stage II. In case of failure of the transfer pump 77, valves 81, 82, 83, 85 and 86 are closed and the pump is replaced.

In the same way the feedstock to be processed is supplied to the hydro-generator 75 by way of the second stage transfer pump 78 via feeding pipeline 93 through valves 94, 95 and 96. The feedstock processed in hydro-generator 75 is fed into the tank of the second stage II via offtake pipeline 97 through valves 98 and 99. Flushing of the hydro-generator 75 and transfer pump 78 is carried out with a diesel fuel from flushing tank 100 through valves 101 and 102 via flushing pipeline 103. Control over the pressure level is carried out using the pressure sensor 104 at the outlet of the transfer pump 78 and by means of the pressure sensor 105 at the outlet of the hydro-generator 75.

The process in hydro-generator 75 is carried out as follows. Valves 101 and 102 on flushing pipeline 103 are closed. The supply of the feedstock to be processed is provided by way of the transfer pump 78 through opened valves 94, 95 and 96. After it has been processed, the feedstock is carried off to the tank of the second stage II via offtake pipeline 97 through opened valves 98 and 99. For flushing hydro-generator 75 valves 94 and 99 are closed and valves 101 and 102 on flushing pipeline 103 are opened; as the result, the transfer pump 78 delivers diesel fuel over by way of the hydro-generator 75 from flushing tank 100. Valves 95, 96 and 98 during the flushing process are opened. When the flushing process is over, valves 101 and 102 are closed, and, if necessary, valve 99 is opened simultaneously; as the result, the flushing fuel is fed into the tank of the second stage II. In case of failure of the transfer pump 78, valves 94, 95, 96, 98 and 99 are closed and the pump is replaced.

In the same way the feedstock to be processed is supplied to hydro-generator 76 by way of the second stage transfer pump 79 via feeding pipeline 106 through valves 107, 108 and 109. The feedstock processed in hydro-generator 76 is fed into the tank of the second stage II via offtake pipeline 110 through valves 111 and 112. Flushing of the hydro-generator 76 and transfer pump 79 is carried out with a diesel fuel from flushing tank 113 through valves 114 and 115 via flushing pipeline 116. Control over the pressure level is carried out using the pressure sensor 117 at the outlet of transfer pump 79 and by means of the pressure sensor 118 at the outlet of the hydro-generator 76.

The process in hydro-generator 76 is carried out as follows. Valves 114 and 115 on flushing pipeline 116 are closed. The supply of the feedstock to be processed is provided by way of the transfer pump 79 through opened valves 107, 108 and 109. After it has been processed, the feedstock is carried off to the tank of the second stage II via of take pipeline 110 through opened valves 111 and 112. For flushing the hydro-generator 76 valves 107 and 112 are closed and valves 114 and 115 on flushing pipeline 116 are opened; as the result, the transfer pump 79 delivers diesel fuel over by means of the hydro-generator 76 from flushing tank 113. Valves 108, 109 and 111 during the flushing process are opened. When the flushing process is over, valves 114 and 115 are closed, and, if necessary, valve 112 is opened simultaneously; as the result, the flushing fuel is fed into the tank of the second stage II. In case of failure of the transfer pump 79, valves 107, 108, 109, 111 and 112 are closed and the pump is replaced.

The processes in hydro-generators 74, 75 and 76 are carried out simultaneously and are repeated not less than 2÷3 times. Temperature control in the tank of the second stage II is carried out by means of the thermocouple probe 119.

Drainage of the flushing fuel from the tank of the second stage II is carried out via pipeline 120 through valve 121.

After processing in hydro-generators 74, 75 and 76 the feedstock from second stage tank II is removed via pipeline 122 through valve 123. The viscometer 124 is installed on the pipeline 122; the needs for further processing of the feedstock is determined according to that viscometer's readings. To the extent that the processing in the tank of the second stage 11 turns out to be sufficient and the viscosity value meets the stated requirements, the final product is drained via pipeline 125 through opened valves 126 and 127 through drain connection 128 with valve 129 closed.

To the extent that the viscosity value does not meet the stated requirements, the feedstock to be processed is directed to the hydro-generator 130 by way of the interim stage's transfer pump 131 via feeding pipeline 122 through valves 132, 133 and 134. The feedstock processed in hydro-generator 130 is fed into the tank of the third stage III via offtake pipeline 135 through valve 136. Flushing of the hydro-generator 130 and transfer pump 131 is carried out with a diesel fuel from flushing tank 137 through valves 138 and 139 via flushing pipeline 140. Control over the pressure level is carried out using the pressure sensor 141 at the outlet of the transfer pump 131 and by means of the pressure sensor 142 at the outlet of the hydro-generator 130. Control over the temperature level is carried out using the temperature sensor 143 at the outlet of the transfer pump 131 and by means of the temperature sensor 144 at the outlet of the hydro-generator 130.

The process in the hydro-generator 130 is carried out as follows. Valves 126 and 129 on drainage pipe 125 as well as valves 138 and 139 on flushing pipeline 140 are closed. The supply of the feedstock to be processed is provided by means of the transfer pump 131 through opened valves 132, 133 and 134. After it has been processed, the feedstock is carried off to the tank of the third stage 111 via offtake pipeline 135 through opened valve 136. For flushing the hydro-generator 130 valves 132 and 134 are closed and valves 138 and 139 on flushing pipeline 140 are opened; as the result, the transfer pump 131 delivers diesel fuel over by way of the hydro-generator 130 from the flushing tank 137. Valve 133 during the flushing process is opened. When the flushing process is over, valves 138 and 139 are closed, and valves 126 and 129 are opened; as the result, the flushing fuel is drained via pipeline 125 through valve 127 of drain connection 128. In case of failure of the transfer pump 131, valves 126, 129, 132, 133 and 134 are closed and the pump is replaced.

3. Third Stage

The feedstock to be processed is fed into the tank of the third stage Ill through valve 136 via pipeline 135. Three hydro-generators 145, 146 and 147, where the cavitation processing of the feedstock is carried out, are placed tangentially to the surface of the tank of the third stage III.

The feedstock to be processed is supplied to hydro-generator 145 by way of the third stage's transfer pump 148 via feeding pipeline 151 through valves 152, 153 and 154. The feedstock processed in hydro-generator 145 is fed into the tank of the third stage III via offtake pipeline 155 through valves 156 and 157. Flushing of the hydro-generator 145 and transfer pump 148 is carried out with a diesel fuel from flushing tank 158 through valves 159 and 160 via flushing pipeline 161. Control over the pressure level is carried out using the pressure sensor 162 at the outlet of the transfer pump 148 and by means of the pressure sensor 163 at the outlet of the hydro-generator 145.

The process in the hydro-generator 145 is carried out as follows. Valves 159 and 160 on flushing pipeline 161 are closed. The supply of the feedstock to be processed is provided by way of the transfer pump 148 through opened valves 152, 153 and 154. After it has been processed, the feedstock is carried off to the tank of the third stage II via offtake pipeline 155 through opened valves 156 and 157. For flushing the hydro-generator 145 valves 152 and 157 are closed and valves 159 and 160 on flushing pipeline 161 are opened; as the result, the transfer pump 148 delivers diesel fuel over by way of the hydro-generator 145 from flushing tank 158. Valves 153, 154 and 156 during the flushing process are opened. When the flushing process is over, valves 159 and 160 are closed, and, if necessary, valve 157 is opened simultaneously; as the result, the flushing fuel is fed into the tank of the third stage III. In case of failure of the transfer pump 148, valves 152, 153, 154, 156 and 157 are closed and the pump is replaced.

In the same way the feedstock to be processed is supplied to the hydro-generator 146, which is provided by means of the third stage's transfer pump 149 via feeding pipeline 164 through valves 165, 166 and 167. The feedstock processed in hydro-generator 146 is fed into the tank of the third stage III via offtake pipeline 168 through valves 169 and 170. Flushing of the hydro-generator 146 and transfer pump 149 is carried out with a diesel fuel from flushing tank 171 through valves 172 and 173 via flushing pipeline 174. Control over the pressure level is carried out using the pressure sensor 175 at the outlet of the transfer pump 149 and by means of the pressure sensor 176 at the outlet of the hydro-generator 146.

The process in hydro-generator 146 is carried out as follows. Valves 172 and 173 on flushing pipeline 174 are closed. The supply of the feedstock to be processed is provided by way of the transfer pump 149 through opened valves 165, 166 and 167. After it has been processed, the feedstock is carried off to the tank of the third stage II via offtake pipeline 168 through opened valves 169 and 170. For flushing the hydro-generator 146 valves 165 and 170 are closed and valves 172 and 173 on flushing pipeline 174 are opened; as the result, the transfer pump 149 delivers a diesel fuel over by means of the hydro-generator 146 from the flushing tank 171. Valves 166, 167 and 169 during the flushing process are opened. When the flushing process is over, valves 172 and 173 are closed, and, if necessary, valve 170 is opened simultaneously; as the result, the flushing fuel is fed into the tank of the third stage III. In case of failure of the transfer pump 149, valves 165, 166, 167, 169 and 170 are closed and the pump is replaced.

In the same way the feedstock to be processed is supplied to the hydro-generator 147, which is provided by means of the of the third stage's transfer pump 150 via feeding pipeline 177 through valves 178, 179 and 180. The feedstock processed in the hydro-generator 147 is fed into the tank of the third stage III via the offtake pipeline 181 through valves 182 and 183. Flushing of the hydro-generator 147 and transfer pump 150 is carried out with a diesel fuel from the flushing tank 184 through valves 185 and 186 via flushing pipeline 187. Control over the pressure level is carried out using the pressure sensor 188 at the outlet of the transfer pump 150 and by means of the pressure sensor 189 at the outlet of the hydro-generator 147.

The process in the hydro-generator 147 is carried out as follows. Valves 185 and 186 on flushing pipeline 187 are closed. The supply of the feedstock to be processed is provided by way of the transfer pump 150 through opened valves 178, 179 and 180. After it has been processed, the feedstock is carried off to the tank of the third stage 111 via the offtake pipeline 181 through opened valves 182 and 183. For flushing the hydro-generator 147 valves 178 and 183 are closed and valves 185 and 186 on flushing pipeline 187 are opened; as the result, the transfer pump 150 delivers a diesel fuel over by way of the hydro-generator 147 from flushing tank 184. Valves 179, 180 and 182 during the flushing process are opened. When the flushing process is over, valves 185 and 186 are closed, and, if necessary, valve 183 is opened simultaneously; as the result, the flushing fuel is fed into the tank of the third stage III. In case of failure of the transfer pump 150, valves 178, 179, 180, 182 and 183 are closed and the pump is replaced.

The processes in hydro-generators 145, 146 and 147 are carried out simultaneously and are repeated not less than 2÷3 times. Temperature control in the tank of the third stage III is carried out by means of the thermocouple probe 190.

After processing in hydro-generators 145, 146 and 147 the feedstock from the tank of the third stage III is removed via pipeline 191 through valve 192. The viscometer 193 is installed on the pipeline 191; the needs for further processing of the feedstock are determined according to that viscometer's readings. To the extent that all the carried out processing is sufficient and the viscosity value meets the stated requirements, the drainage of the final product is carried out. To the extent that the viscosity value does not meet the predetermined values, the feedstock being processed is returned to the tank of the first stage I.

Drainage of the flushing fuel from flushing tanks 18, 31 and 44 of the first stage I is carried out via drainage pipes 194, 195 and 196 respectively and correspondingly by ways of valves 197, 198 and 199.

Drainage of the flushing fuel from the flushing tank 66 of the interim stage is carried out via drainage pipe 200 through valve 201.

Drainage of the flushing fuel from flushing tanks 87, 100 and 113 of the second stage II is carried out via drainage pipes 202, 203 and 204 respectively and correspondingly by ways of valves 205, 206 and 207.

Drainage of the flushing fuel from the flushing tank 137 of the interim stage is carried out via drainage pipe 208 through valve 209.

Drainage of the flushing fuel from flushing tanks 158, 171 and 184 of the third stage III is carried out via drainage pipes 210, 211 and 212 respectively and correspondingly by ways of valves 213, 214 and 215.

Control over the temperature level at the outlets of the first stage's transfer pumps 8, 9 and 10 is carried out using temperature sensors 216, 217 and 218 correspondingly. Control over the temperature level at the outlets of first stage hydro-generators 5, 6 and 7 is carried out using temperature sensors 219, 220 and 221 correspondingly.

In the same way control over the temperature level at the outlets of second stage transfer pumps 77, 78 and 79 is carried out using temperature sensors 222, 223 and 224 correspondingly. Control over the temperature level at the outlets of second stage's hydro-generators 74, 75 and 76 is carried out using temperature sensors 225, 226 and 227 correspondingly.

In the same way control over the temperature level at the outlets of third stage transfer pumps 148, 149 and 150 is carried out using temperature sensors 228, 229 and 230 correspondingly. Control over the temperature level at the outlets of third stage's hydro-generators 145, 146 and 147 is carried out using temperature sensors 231, 232 and 233 correspondingly.

In order to prevent getting any unprocessed feedstock to a consumer, an additional stage is provided at the third stage outlet. In this case the feedstock being processed is supplied via pipeline 234 with closed valves 235 and 236 on drainage pipe 237 to the hydro-generator 238 by means of the final stage transfer pump 239 through valves 240, 241 and 242. Flushing of the hydro-generator 238 and transfer pump 239 is carried out with a diesel fuel from flushing tank 243 through valves 244 and 245 via flushing pipeline 246. Drainage of the flushing fuel from flushing tank 243 is carried out via drainage pipe 247 through valve 248.

To the extent that the processing in the facilities turns out to be sufficient and the viscosity value meets the stated requirements, the final product is drained via pipeline 237 through opened valves 235 and 250 through drain connection 249 with valve 236 closed.

Control over the pressure level is carried out using pressure sensor 251 at the outlet of the transfer pump 239 and by means of the pressure sensor 252 at the outlet of the hydro-generator 238. Control over the temperature level is carried out using temperature sensor 253 at the outlet of the transfer pump 239 and by means of the temperature sensor 254 at the outlet of the hydro-generator 238.

The process in hydro-generator 238 is carried out as follows. Valves 235 and 236 on drainage pipe 237 as well as valves 244 and 245 on flushing pipeline 246 are closed. The supply of the feedstock to be processed is provided by way of the transfer pump 239 through opened valves 240, 241 and 242. After it has been processed, the feedstock is carried off to a consumer via offtake pipeline 255. For flushing hydro-generator 238 valves 241 and 242 are closed and valves 244 and 245 on flushing pipeline 246 are opened; as the result, the transfer pump 239 delivers diesel fuel over by means of the hydro-generator 238 from flushing tank 243. Valve 240 during the flushing process is opened. When the flushing process is over, valves 244 and 245 are closed, and valve 248 is opened; as the result, the flushing fuel is drained through drain connection 247. In case of failure of the transfer pump 239, valves 235, 236, 240, 241 and 242 are closed and the pump is replaced.

For flushing the feeding pump 2 valve 3 is closed and valves 257 and 258 on the flushing pipeline 259 are opened; as the result, the transfer pump 2 delivers a diesel fuel over from the flushing tank 256. When the flushing process is over, valves 257 and 258 are closed, and valve 261 is opened; as the result the flushing fuel is drained through drain connection 260. In case of failure the transfer pump 2, valve 3 is closed and the pump is replaced.

Readings of viscometers 53, 124 and 193 allow to determine whether it is necessary to intensify the processing of the feedstock or, vice versa, to decrease its intensity, i.e. to decrease the number of passes through each hydro-generator, or to selectively shut down hydro-generators of the first, second or third stage.

The principal chart shown on the FIG. 2 combines the parallel and the sequential layouts of the hydro-generators described earlier. The advantages of the said chart are as follows:

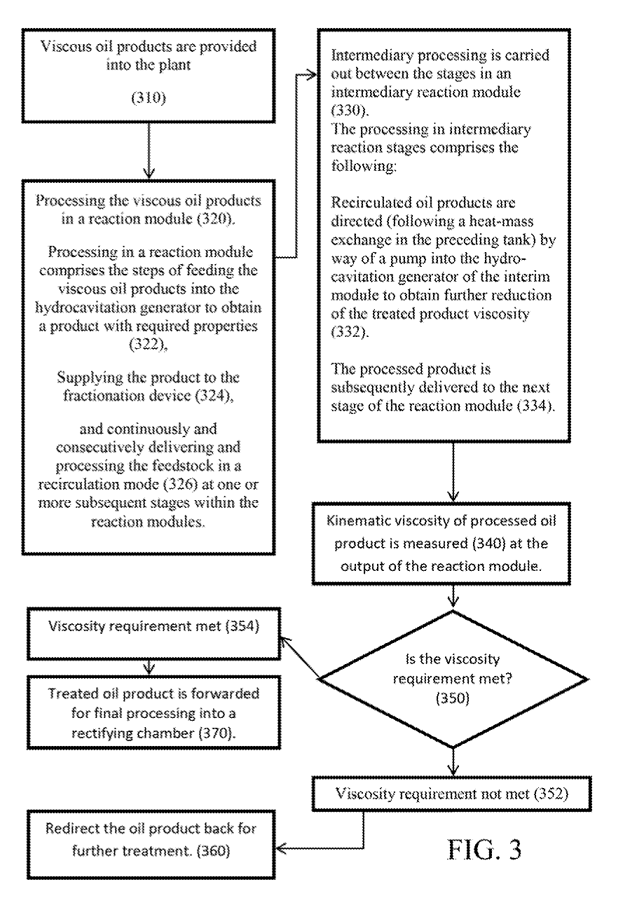

1. At the starting stage a hot diesel fuel is fed into the tank of the first stage I along with the feedstock proper. Because of that an initial decrease of the feedstock's viscosity takes place due to a temperature increase, thus less power is required for directing movement of a viscous feedstock and therefore the process of cavitation in hydro-generators is achieved and carried out more easily.
2. With a availability of selectively locating the hydro-generators there exists a possibility to regulate the intensity of the viscosity reduction process depending on the level of viscosity of the initial feedstock and on the specified viscosity of the product at the outlet: to reduce the number of the feedstock's passes through each hydro-generator or to change the number of hydro-generators themselves.
3. Replacement of any malfunctioned equipment will not lead to downtime of the whole processing facilities as the replacement can be carried out during the process.
FIG. 3 is a flowchart, illustrating steps of one of the preferred embodiments of the method of the present invention. The following steps are illustrated:

Viscous oil products are provided into the plant (310). The viscous oil products are then processed in a reaction module (320). Processing in a reaction module comprises the steps of feeding the viscous oil products into the hydrocavitation generator (322) to obtain a product, supplying the product to the fractionation device (324), and continuously and consecutively delivering and processing the feedstock in a recirculation mode (326) at one or more subsequent stages within the reaction modules.

The intermediary processing is carried out (330) between the stages in an intermediary reaction module. The processing in intermediary reaction stages comprises the following. Recirculated oil products are directed (332) (following a heat-mass exchange in the preceding tank) by way of a pump into the hydrocavitation generator of the interim module to obtain further reduction of the treated product viscosity. The processed product is subsequently delivered (334) to the next stage of the reaction module.

Kinematic viscosity of processed oil product is then measured (340) at the output of the reaction module to ascertain whether the viscosity requirement is met (350). The viscosity requirement may be met (352) or not met (354).

In some embodiments of the present method, the treated oil product may be redirected back to the tank of the preceding stage (360) for further treatment.

In circumstances, where it is determined that the level of viscosity has reached the preset value (352), the treated oil product is forwarded for final processing into a rectifying chamber (370).

It is to be understood that while the plant and the method of the present invention have been described and illustrated in detail, the above-described embodiments are simply illustrative of the principles of the invention and the forms that the invention can take, and not a definition of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the claims below.

I claim:

1. A plant for processing viscous oil and oil products, said plant comprising:
a plurality of reaction modules,
a plurality of rectifying chambers,
pipelines;
a plurality of hydrocavitation generators;
wherein,
each reaction module of a plurality of reaction modules comprises:
a reaction module's tank,
a pump and
at least one of the plurality of hydrocavitation generators;
with each reaction module of a plurality of reaction modules further comprising a plurality of intermediate reaction stages,
said plurality of intermediate reaction stages further comprising a last intermediary reaction stage;
wherein,
each rectifying chamber of the plurality of rectifying chambers, comprises:
a rectifying chamber tank,
a rectifying pump
at least one of the plurality of hydrocavitation generators; and
each rectifying chamber of the plurality of rectifying chambers comprises a plurality of intermediate rectifying stages;
wherein:
the reaction module and the rectifying chamber are interconnected;
the plurality of intermediate reaction stages are connected by pipelines;
the last intermediary reaction stage is connected by the pipelines to a rectifying chamber;
each of the plurality of intermediate reaction stages comprises a tank, a pump and at least one of the plurality of hydrocavitation generators; said at least one of the plurality of hydrocavitation generators comprising an outlet pipe;
and wherein
the outlet pipe of a hydrocavitation generator is connected via the inlet pipe to the reaction module's tank.

2. The plant of claim 1, wherein each reaction module of a plurality of reaction modules comprises at least one of the plurality of hydrocavitation generators;
with each of the at least one of the plurality of hydrocavitation generators comprising a pump,
said pump connected within the reaction module by parallel pipelines.

3. The plant of claim 1, wherein, each intermediate reaction stage of the plurality of intermediate reaction stages comprises an automatic support system,
wherein said automatic support system is configured to maintain steady-state temperature conditions,
said steady-state temperature conditions configured and maintained to be constant and equal to a mass-averaged temperature of the product in the tank.

4. The plant of claim 1, wherein each reaction module's tank, of each reaction module of a plurality of reaction modules, comprises a fitting,
said fitting configured for gaseous fraction discharge and for extraction of noncondensing gases.

5. The method for processing viscous oil and viscous oil products, intended to achieve, among other things (such as environmental benefits and cost savings), viscosity reduction, refining and cracking, comprising the steps of:
a. providing a plant for processing viscous oil and oil products, said plant comprising:
a plurality of reaction modules,
a plurality of rectifying chambers,
pipelines;
a plurality of hydrocavitation generators;
wherein,
each reaction module of a plurality of reaction modules comprises:
a reaction module's tank,
a pump and
at least one of the plurality of hydrocavitation generators;
with each reaction module of a plurality of reaction modules further comprising a plurality of intermediate reaction stages;
said plurality of intermediate reaction stages further comprising a last intermediary reaction stage;
wherein,
each rectifying chamber of the plurality of rectifying chambers, comprises:
a rectifying chamber tank,
a rectifying pump
at least one of the plurality of hydrocavitation generators; and
each rectifying chamber of the plurality of rectifying chambers comprises a plurality of intermediate rectifying stages;
wherein:
the reaction module and the rectifying chamber are interconnected;
the plurality of intermediate reaction stages are connected by pipelines;
the last intermediary reaction stage is connected by the pipelines to a rectifying chamber;
each of the plurality of intermediate reaction stages comprises a tank, a pump and the at least one of the plurality of hydrocavitation generators; said at least one of the plurality of hydrocavitation generators comprising an outlet pipe;
and wherein
the outlet pipe of a hydrocavitation generator is connected via the inlet pipe to the reaction module's tank;
b. providing viscous oil products,
c. processing the viscous oil products in a reaction module, said processing in a reaction module comprising the steps of
i. feeding the viscous oil products into the hydrocavitation generator to obtain a product with required properties,
ii. supplying the processed product to the fractionation device,
iii. continuously and consecutively delivering and processing the feedstock in a recirculation mode at one or more subsequent stages within the reaction modules.

6. The method of claim 5, further comprising the steps of:
a. carrying out the intermediary processing between the stages in an intermediary reaction module, said processing in intermediary reaction stages comprising the steps of:
i. directing recirculated oil products (following a heat-mass exchange in the preceding tank) by way of a pump into the hydrocavitation generator of the interim module to obtain further reduction of the treated product viscosity,
ii. subsequent delivery of the processed product to the next stage of the reaction module;
b. measuring kinematic viscosity of processed oil product at the output of the reaction module to ascertain whether the viscosity requirement is met.

7. The method of claim 6, further comprising the step of redirecting the treated oil product back to the tank of the preceding stage for further treatment.

8. The method of claim 6, further comprising the steps of determining that the level of viscosity has reached the preset value and of forwarding the treated oil product for final processing into a rectifying chamber.

9. The method of claim 6, wherein:
the processing is carried out in one or more parallel-operating hydrocavitation generators out of the plurality of hydrocavitation generators at each stage of reaction modules;
the mass flow of the product fed into the one or more hydrocavitation generators is equal to a multiple of the mass flow of the product fed into a reaction module.

10. The method of claim 6, wherein:
the processing is carried out in a plurality of parallel-operating hydrocavitation generators out of the plurality of hydrocavitation generators at each stage of reaction modules;
the mass flow in each of hydrocavitation generators is configured to be equal to the mass flow of the product delivered for processing.

11. The method of claim 5, wherein under steady-state conditions the temperature in the reaction module's tank at each reaction module stage is configured to be maintained constant and equal to a mass-averaged temperature of the product in the reaction module's tank.

12. The method of claim 5, further comprising a step of removing noncondensing gases from each tank.

13. The plant for processing viscous oil and oil products with interconnected reaction module and rectifying chamber, each containing a tank, a pump and a swirling hydrocavitation generator, is characterized by the fact that the plant contains one or more stages of reaction modules connected by pipelines. Between them intermediary reaction stages are provided and the last intermediary stage is connected by a pipeline to a rectifying chamber. Each reaction module contains a tank, a pump and a hydrocavitation generator connected by pipelines, the outlet pipe of a hydrocavitation generator is connected to the reaction module's tank; intermediary reaction modules contain a pump and a hydrocavitation generator.

14. The plant of claim 13, wherein is each reaction module comprises a plurality of hydrocavitation generators, said generators connected by parallel pipelines, using their own pumps.

15. The plant of claim 13, wherein each reaction module's stage is provided with an automatic support system under steady-state temperature conditions maintained constant and equal to a mass-averaged temperature of the product in a tank.
